(19) United States
(12) Patent Application Publication
(10) Pub. No.: US 2015/0290072 A1
(43) Pub. Date: Oct. 15, 2015

(54) Cervical Traction Device

(71) Applicant: Balraj Singhal, Christchurch (NZ)

(72) Inventor: Balraj Singhal, Christchurch (NZ)

(21) Appl. No.: 14/424,316

(22) PCT Filed: Aug. 28, 2013
(86) PCT No.: PCT/IB2013/058043

§ 371 Date: Feb. 26, 2015

(30) Foreign Application Priority Data
Aug. 31, 2012 (NZ) 602167

(51) Int. Cl. A61H 1/02

(52) U.S. Cl. CPC A61H 1/0296; A61H 2205/04

(57) ABSTRACT

A device for applying traction to the cervical vertebrae to reduce fracture dislocation of the cervical spine, said device including: a support surface adapted to support a patient lying upon his or her back; a load transmitting means adapted to be connected at one end to a patient under treatment and lying upon said support surface; the other end of said load transmitting means being adapted to be connected to a load applying means; said load applying means being movable along a regular or irregular curve to any of a range of predetermined positions between a first position which places the patient's cervical spine in flexion and a second position which places the patient's cervical spine in extension.

### FIELD OF INVENTION

The present invention relates to a traction device, and in particular to a device for applying traction to the cervical vertebrae, and reducing fracture dislocations of the cervical spine.

### BACKGROUND OF THE INVENTION

Any discussion of the prior art throughout the specification is not an admission that such prior art is widely known or forms part of the common general knowledge in the field.

Spinal cord trauma can be caused by a wide range of injuries to the spine, resulting from, for example, motor vehicle accidents, falls, and sports injuries. Spinal cord trauma affecting the cervical vertebrae, (i.e. C1-C7 vertebrae) can be especially serious, in that it affects everything below the side of the trauma, and thus can affect the arms and legs, as well as causing breathing difficulties. Spinal cord trauma affecting cervical vertebra is a distressingly common result of motor vehicle accidents, rugby accidents and diving accidents caused by diving into shallow water.

In all cases of spinal cord trauma, rapid treatment is necessary to reduce the long-term effects; the treatment usually includes spinal traction to reduce dislocation and produce the necessary anatomic realignment. Surgery also is necessary in some cases.

It has been found that rapid treatment (preferably within four hours or less of the accident) can be particularly effective in the case of low velocity injuries to the cervical vertebrae. Typically, low velocity injuries are caused by sports accidents, e.g. accidents during rugby, or trampolining or wrestling or gymnastics. Low velocity injuries typically cause damage in the form of a kink in the spinal cord, but the damage is at a sufficiently low level that if traction can be applied rapidly, soon after the injury, it is possible to achieve a complete, or almost complete, recovery.

Over the last several centuries, a number of devices have been proposed to apply traction to the spine. Many of the devices for this purpose are essentially physiotherapy devices, which are designed simply to apply a lower level of traction to various parts of the spine, as part of a regular physiotherapy treatment, or to relieve relatively mild discomfort, as opposed to applying traction specifically to realign damaged cervical vertebrae.

For applying traction for medical treatment purposes, the most commonly used medical apparatus involves an arcuate harness which is secured to the patient's skull and connected to one end of a rope, the other of which passes over a pulley and carries weights. The weights are loaded onto a hangar and can be increased or decreased as necessary.

This arrangement has the merit of being relatively inexpensive, and simple to use. However, in this arrangement the weights hang freely near the end of the bed on which the patient is supported, and are vulnerable to being knocked against and displaced. Further, once traction has been applied, the patient cannot be moved whilst under traction. Another drawback is the force applied by the traction cannot be increased gradually, but only in set increments depending upon the size of the weights being applied. A further drawback is that it is not possible to vary the angle at which the weights are applied to the patient.

A number of devices have been proposed, which avoid the use of free hanging weights—see for example U.S. Pat. No. 6,984,217. However, none of the existing devices for applying traction allow traction to be applied through a wide angular range, so that the traction can not only be applied along a neutral line, (i.e. approximately in line with the undamaged portion of the spine), but can also be applied from above the patient so as to place the spine in flexion (i.e. forward bend), and below the patient, so as to place the spine in extension (i.e. backward bend.

### SUMMARY OF THE INVENTION

An object of the present invention is the provision of a traction device suitable for applying traction to the cervical vertebrae, which allows traction to be applied through a sufficiently wide angular range so as to place the spine in flexion or in extension or in any of a range of preselected positions between these two extremes.

The present invention provides a device for applying traction to the cervical vertebra to reduce fracture dislocation of the cervical spine, said device including:

a support surface adapted to support a patient lying upon his or her back;

a load transmitting means adapted to be connected at one end to a patient under treatment and lying upon said support surface;

the other end of said load transmitting means being adapted to be connected to a load applying means;

said load applying means being movable along a regular or irregular curve to any of a range of predetermined positions between a first position which places the patient's cervical spine in flexion and a second position which places the patient's cervical spine in extension.

In a preferred embodiment of the present invention, the load applying means is mounted upon a support which is in the shape of a regular or irregular curve and which is adapted to be moved relative to said support surface so as to move said load applying means between said first and second positions. The support may be formed as a gear rack which is adapted to be moved relative to said support by means of a pinion connected to said support surface.

Another possibility is to mount said load applying means upon a support in the shape of a regular or irregular curve, said load applying means being adapted to move relative to said support, between said first and second positions.

Preferably, the angle between said first and second positions is at least 90°.

The curve through which the load applying means can be moved may be a regular or irregular curve, but preferably is a regular curve formed as an arc of a circle with a radius of about 650 mm.

Any suitable load applying means may be used.

The load transmitting means may be any suitable rigid, semirigid or flexible load transmitting means. Preferably, however, the load transmitting means is flexible, e.g. a wire or a wire rope, used in conjunction with a load applying means in the form of a winch which provides a winch drum around which the load transmitting means is wound.

Preferably, the support surface is adapted to be tiltable between a base position in which the plane of the support surface is substantially horizontal and a tilted position in which the plane of the support surface is at at least 45° to the horizontal, and to any of a range of predetermined positions between said base and said tilted positions.

The actual load to be applied to the patient depends upon a number of factors which include the type of treatment being used, the weight of the patient, and the angle at which the load is to be applied. Typical loads are in the range 2 kg to 50 kg.

Preferably, the device includes a load measuring means arranged such that in use the load measuring means reads the load on said load transmitting means. The load measuring means may be any suitable measuring device capable of accurate measurement, and preferably is a load cell. The load measuring means may be mounted adjacent the load applying means, but could be incorporated in the load transmitting means or connected between the load transmitting means and the load applying means.

### BRIEF DESCRIPTION OF THE DRAWINGS

By way of example only, a preferred embodiment of the present invention is described in detail, with reference to the attached drawings, in which:—

FIG. 1 is a diagrammatic side view of a support surface and a traction device in accordance with the present invention, showing the application of neutral traction;

FIG. 2 is a view similar to FIG. 1, but with the support surface tilted;

FIG. 3 is a view similar to FIG. 2, with the traction device applying maximum flexion;

FIG. 4 is a view similar to FIG. 1, but with the traction device applying maximum extension;

FIG. 5 is a view of part of the traction device, on a larger scale, with the rack and pinion shown straight rather than curved, for clarity;

FIG. 6 is a side view of the load applying means; and

FIG. 7 is a plan view of the load applying means.

### DETAILED DESCRIPTION OF THE PREFERRED EMBODIMENT

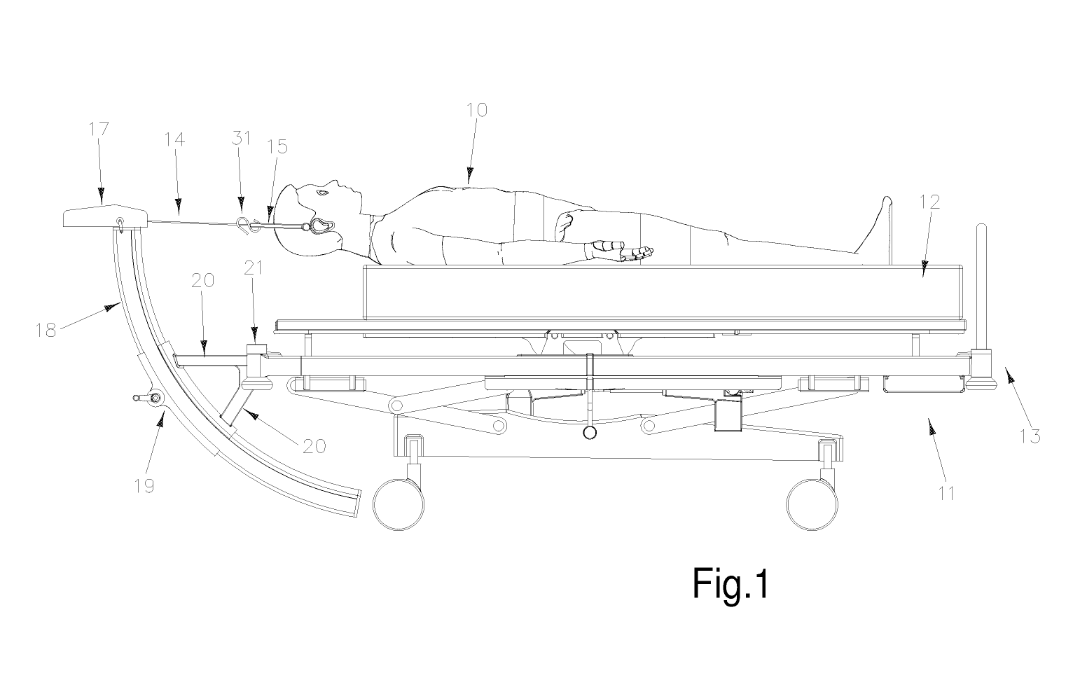

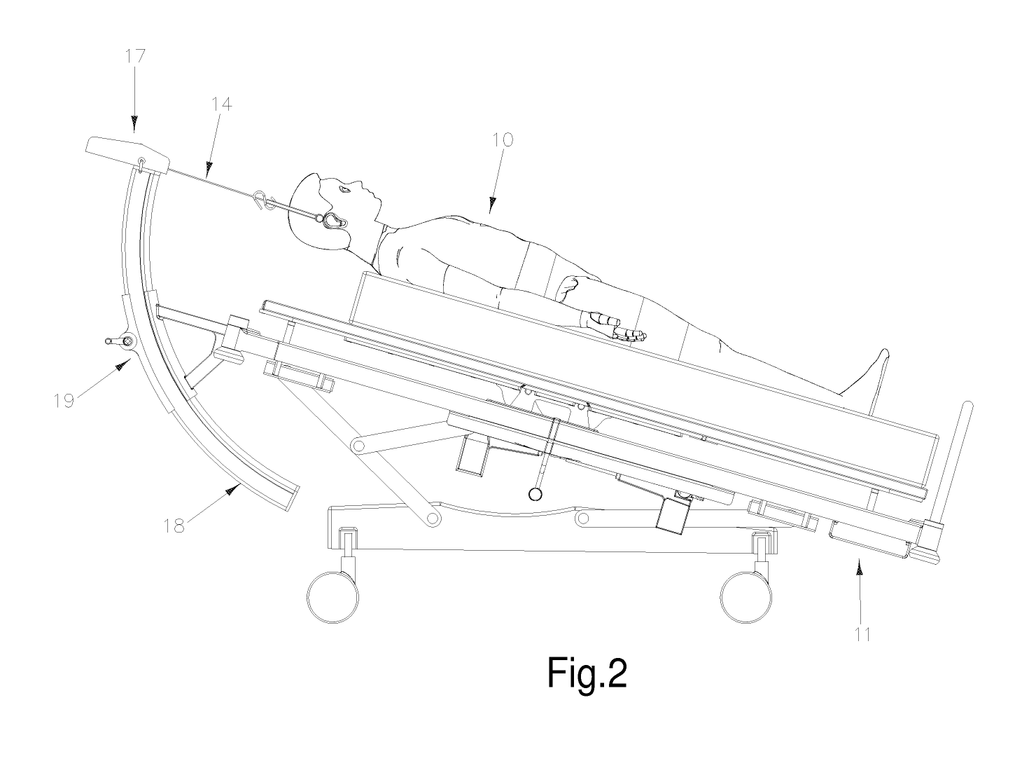

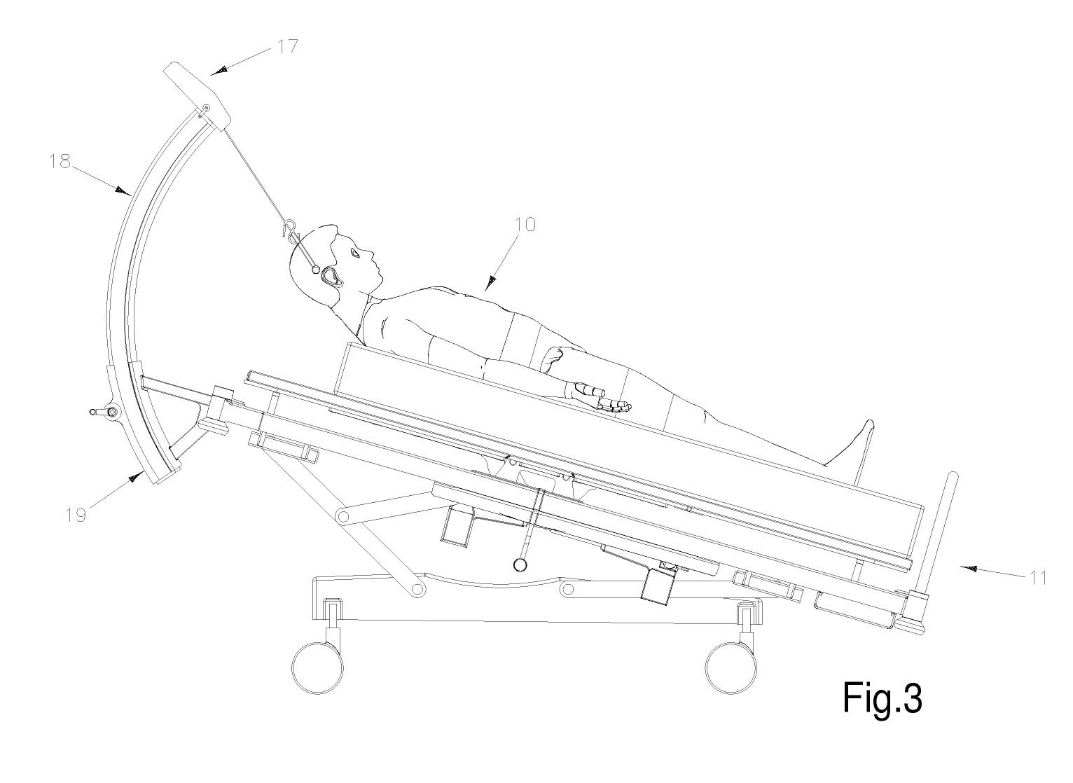

Referring to the drawings, as shown in FIGS. 1-4, a patient 10 to be treated for fracture dislocations of the cervical spine is supported upon a support surface 11 in the form of a Howard Wright trauma stretcher. The trauma stretcher is of known type, and provides a mattress 12 carried upon a mobile base 13 which can be adjusted in angle (see FIGS. 2 and 3). The base 13 can be tilted from the ‘base’ position shown in

FIG. 1, in which the plane of the base is substantially horizontal, up to a position in which the plane of the base is at about 25° to the horizontal, or even up to 45°. The base 13 also may be tilted to any of a range of positions between these extremes. The stretcher also provides means for securing the patient to the stretcher, so that traction can be applied as described below without actually pulling the patient along the stretcher.

For clarity, in the drawings the head of the patient 10 is shown unsupported, with the patient's shoulders aligned with the end of the mattress; in practice the patient's head is supported by a pillow.

A flexible load transmitting means 14, in the form of a wire rope, is connected at one end to the patient 10 by Gardner Wells tongs 15. The tongs are of known design, and the free ends of the tongs are connected directly into a patient's skull.

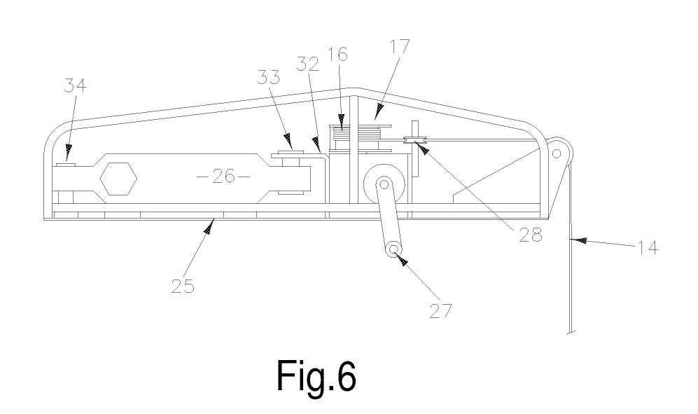

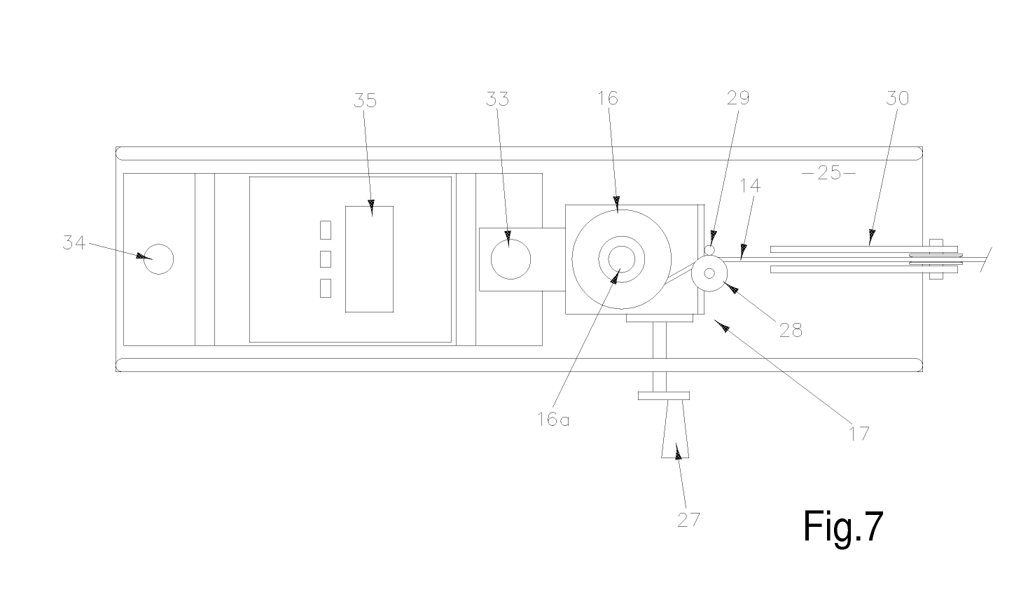

The other end of the wire rope 14 is wound around the drum 16 of a load applying means in the form of a winch 17 (see FIGS. 6 and 7).

The winch 17 is mounted at one end of a curved support 18 which forms the rack of a rack and pinion drive, the pinion 19 being rigidly secured to the midpoint of the end of the trauma stretcher 11, adjacent the head of a patient 10 in use, by means of a bracket 20 and a clamp 21.

It is important that the length of the bracket 20 is sufficient to space the device from the head of the stretcher:—there must be room for the rack 18 to move relative to the pinion whilst remaining clear of the stretcher, and the length of the wire 14 between the patient and the winch should be at least 300 mm at the start of the procedure, to allow adequate scope for increasing the tension as necessary.

The pinion 19 is curved to match the curve of the rack 18. The rack 18 is shown as a smooth, arcuate, curve, but may in fact be formed as any of a range of regular or irregular curves, and preferably is formed as a C shape. Forming the rack 18 as a smooth arc with a radius of about 650 mm has been found to work well in practice. In practical terms, the radius of the curve of the rack 18 (if regular) or the shape of the rack 18 (if irregular) must be such that the load applying means can be positioned to apply everything from a maximum extension load, through a neutral load, to a maximum flexion load to a patient, but such that the rack 18 does not contact the floor or the stretcher in any position; and preferably such that the rack 18 is not inconveniently high above the stretcher either. Within these practical limits, the radius and shape of the curve of the rack may be varied as required.

The above described arrangement of means that the angle at which traction is applied to a patient can be varied by moving the rack 18 relative to the pinion 19 to raise or lower the winch 17 relative to a patient supported upon the stretcher, and the angle can also be varied by tilting the stretcher, as shown in FIGS. 2 and 3.

The degree of traction applied to a patient can be increased or decreased by winding more or less of the wire rope 14 around the drum 16 of the winch 17, but also can be varied by varying the angle at which the traction is applied:—increasing the angle at which traction is applied will not only increase the degree of flexion of the cervical vertebrae, but also increase the load applied. Conversely, decreasing the angle at which traction is applied will decrease the degree of flexion, and if the neutral point has been passed, (i.e. where the load is applied aligned with the undamaged portion of the patient's spine) will increase the extension, and will also increase the load applied.

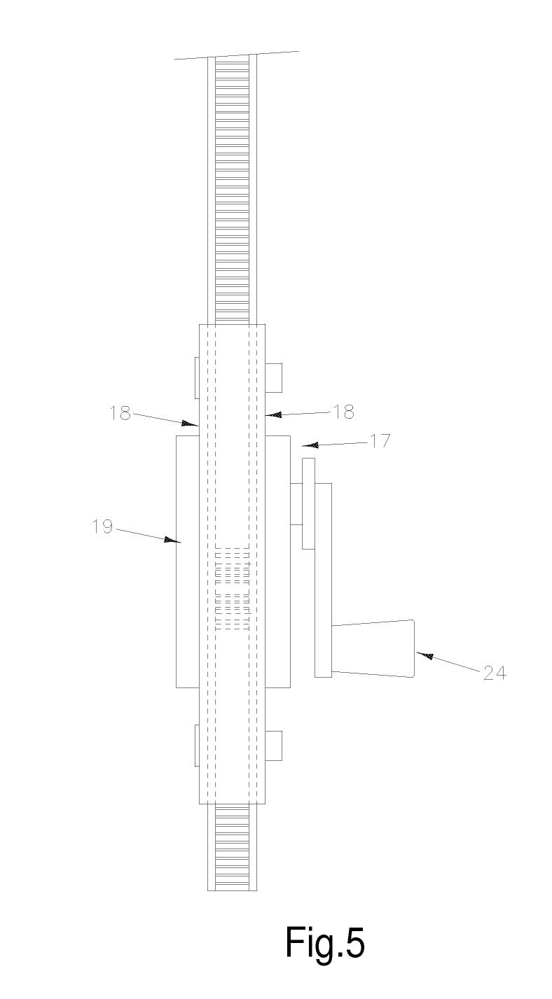

FIG. 5 shows a detail of the rack and pinion, but with both the rack and the pinion shown straight rather than curved, for clarity. The rack 18 is formed along the whole of its length as a gear rack which engages with a pinion 19 mounted inside a mounting box 23. The pinion 19 can be rotated by means of a handle 24 via a right angle geared worms/worm wheel drive (not shown) of known type. Preferably, the gear ratio is 40:1, so that very fine adjustments can be provided by rotating the handle. It would of course be possible to drive the pinion using motorised drive means, if preferred.

Thus, rotating the handle 24 moves the rack 18 up or down relative to the pinion 19, depending upon the direction of rotation of the handle.

FIGS. 6 and 7 show the winch 17 in greater detail. The winch 17 is carried on a plate 25, which also supports a load cell 26 as described below. The underside of the plate 25 is secured to the upper end of the track 18 such that in the neutral position shown in FIG. 1, the plane of the plate 25 is substantially horizontal.

The winch 17 is a small geared winch powered by a winding handle 27 which can be manually rotated to rotate the winch drum 16 around an axle 16a, via a right angle geared drive (not visible) mounted below the winch drum 16. Preferably the gear ratio is 30:1 so that very small movements of the winch wire 14 are possible. The winch 17 could be driven by a motor if preferred.

One end of the wire rope 14 is permanently secured to the drum 16; the winch wire 14 passes from the drum 16, between a freely rotatable guide pulley 28 and a peg 29, and over a second free rotatable guide pulley 30 which directs the winch wire 14 outwards to hook onto the Gardner Wells tongs 15 secured to the patient, by means of a hook 31 secured to the free end of the wire rope.

One side of the winch 17 is mounted on an angled plate 32 which is bent through a right angle. The other side of the plate 32 is apertured to receive a bolt 33 which provides a load transmitting connection to the load cell 26. The other end of the load cell 26 is anchored by means of a bolt 34 to the plate 25. The winch 17 and plate 32 can slide relative to the plate 25, so that the load on the wire rope 14, which is of course transmitted to the winch drum 16, is recorded by the load cell 26. Thus, as the handle 27 of the winch is rotated in either direction, the increase or decrease of the load on the wire 14 can be read directly from the display 35 of the load cell 26.

The above described device is used as shown in FIGS. 1-4. The patient 10 lies on the stretcher 11 and is secured using known means (not shown). A Gardner Wells tongs 15 is connected to the patient's skull in known manner, and the wire rope 14 from the winch 17 is hooked onto the tongs 15 by the hook 31.

In the position shown in FIG. 1, the stretcher 11 provides a support surface in the horizontal plane, and the rack 18 is positioned so that the winch 17 is approximately opposite the end of the patient's spine. This means that the wire rope 14, when tensioned by the winch 17, applies a neutral traction to the patient, i.e. in a direction aligned with the undamaged portion of the patient's spine.

The objective of the traction is to rapidly but gently reduce any distortion of the spinal cord, to remove abnormal pressure from the spinal cord, and to realign any displaced portions of the spine.

In the neutral position shown in FIG. 1, the winch wire is used to apply a loading of (typically) 2 to 2.5 kg. X-rays normally are taken before starting treatment, and also taken at every stage during treatment with the device:—the patient is x-rayed after every five kg increase in loading.

In the next stage of treatment, the leg end of the stretcher 11 is lowered to an angle of about 16° to the horizontal, as shown in FIG. 2. This maintains a straight, (i.e. neutral) traction on the patient, but increases the load applied to the patient, e.g. to 5 kg. The rack 18 is then slowly moved relative to the pinion 19, using the hand wheel 24, to raise the winch 17 to the position shown in FIG. 3 thus gradually increasing the flexion of the cervical spine, to realign that portion of the spinal cord to the correct alignment. The full limit of maximum flexion is when the patient's chin contacts his or her chest. If necessary, the load applied by the winch 17 may be raised during this stage, e.g. to 15 kg.

In general, increasing the angle of the load increases the degree of flexion of the cervical vertebrae and also increases the load applied. Decreasing the angle of the load decreases the degree of flexion and also decreases the load applied, until the neutral loading point has been passed, as described above.

It will be appreciated that the degree of loading, and the angle at which the traction is applied, both are varied depending upon the patient's size and weight and the degree and type of damage to the spine:—a constant monitoring of the treatment by means of x-rays of the cervical spine area are needed to make sure that both the traction and the degree of flexion or extension are kept to the minimum needed for the desired effect.

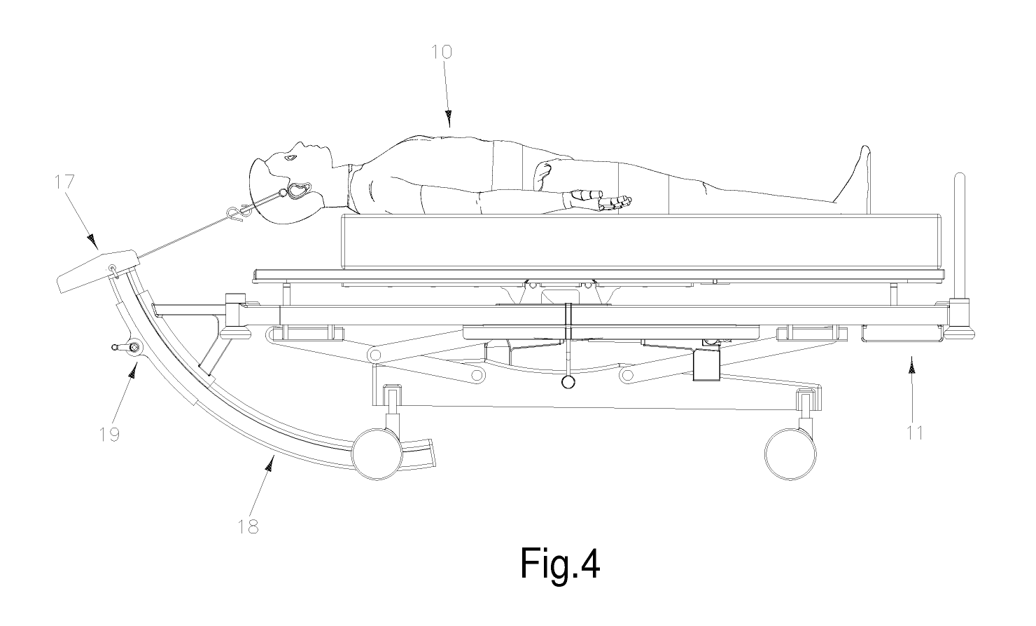

When the x-rays indicate that the dislocated vertebra(e) has been correctly reduced, i.e. realigned, the stretcher 11 is gradually moved back to the horizontal position shown in FIG. 4, and the angle of traction is gradually reversed to place the cervical spine in extension rather than flexion:—this means that the winch 17 is actually at a level below the patient's head, as shown in FIG. 4. Maintaining the cervical spine in extension, at a relatively low traction loading, maintains the reduction of the spine without over distracting the spine. When the spine is in extension, typically the loading in kilograms applied by the winch is the same as the number of the vertebra at the break—C5 break has a 5 kg loading, C4 break has a 4 kg loading, and so on.

1. A device for applying traction to the cervical vertebrae to reduce fracture dislocation of the cervical spine, said device including:
a support surface adapted to support a patient lying upon his or her back;
a load transmitting means adapted to be connected at one end to a patient under treatment and lying upon said support surface;
the other end of said load transmitting means being adapted to be connected to a load applying means;
said load applying means being movable along a regular or irregular curve to any of a range of predetermined positions between a first position which places the patient's cervical spine in flexion and a second position which places the patient's cervical spine in extension.

2. The device as claimed in claim 1, wherein the angle between said first and second positions is at least 90°.

3. The device as claimed in claim 1, wherein the load applied by the load applying means is in the range 2 kg-50 kg.

4. The device as claimed in claim 1, wherein said device further includes a load measuring means arranged such that in use said load measuring means measures the load on said load transmitting means.

5. The device as claimed in claim 4, wherein said load measuring means comprises a load cell.

6. The device as claimed in claim 4 wherein said load measuring means is located in a position selected from: adjacent the load applying means; incorporated in the load transmitting means; connected between the load transmitting means and the load applying means.

7. The device as claimed in any one of the preceding claims wherein the load transmitting means is flexible and the load applying means consists of a winch providing a winch drum around which the load transmitting means is wound.

8. The device as claimed in claim 1 wherein said support surface is adapted to be tiltable between a base position in which the plane of the support surface is substantially horizontal and a tilted position in which the plane of the support surface is at at least 45° to the horizontal, and to any of a range of predetermined positions between said base and tilted positions.

9. The device as claimed in claim 1 or claim 8 wherein said load applying means is mounted upon a support which is in the shape of a regular or irregular curve and which is adapted to be moved relative to said support surface so as to move said load applying means between said first and second positions.

10. The device as claimed in claim 9 wherein said support is formed as a gear rack which is adapted to be moved relative to said support surface by means of a pinion connected to said support surface.

11. The device as claimed in claim 1 or claim 8 wherein said load applying means is mounted upon a support in the shape of a regular or irregular curve, and said load applying means is adapted to move relative to said support, between said first and second positions.

12. The device as claimed in claim 1 or claim 8 wherein said load applying means is movable along a regular curve which comprises an arc of a circle having a radius of about 650 mm.
